(19) United States
(12) Patent Application Publication
(10) Pub. No.: US 2003/0061164 A1
(43) Pub. Date: Mar. 27, 2003

(54) Intellectual property brokerage system and method

(76) Inventor: William Muhammad, Silver Spring, MD (US)

Correspondence Address: Supervisor, Patent Prosecution Services, Piper Marbury Rudnick & Wolfe LLP, 1200 Nineteenth Street, N.W., Washington, DC, 20036-2412, US

(21) Appl. No.: 09/727,489

(22) Filed: Dec. 4, 2000

Related U.S. Application Data
(60) Provisional application No. 60/168,629, filed on Dec. 3, 1999.

(51) Int. Cl. G06F 17/60; H04K 1/00

(52) U.S. Cl. 705/52

(57) ABSTRACT

Intellectual property owner's computer is sold to buyers through a kiosk. The kiosk provides users with the ability to locate desired content on a seller's computer. When a user locates the desired intellectual property, a payment transaction is initiated. When the payment transaction is complete, the seller transmits the intellectual property to the kiosk. The kiosks also preferably include production facilities that transfer the owner's intellectual property onto a permanent medium and/or presentation facilities that present the owner's intellectual property on a one-time basis.

This application claims priority from U.S. Provisional Application Serial No. 60/168,629 filed Dec. 3, 1999. The entirety of that provisional application is incorporated herein by reference.

### BACKGROUND OF THE INVENTION

1. Field of the Invention

The invention relates to the distribution of intellectual property generally and more particularly to a system and method for brokering the electronic transfer of intellectual property.

2. Discussion of the Background

The current system for the sale and distribution of intellectual property is characterized by the delivery of physical media imprinted with a copy of the intellectual property content. An elaborate distribution chain moves the physical media from factory to distributor to retail store. During the 1970s this model was updated by storing digitized content on central computers and then downloading the content to kiosks for copying onto media. This client/server model is characterized by a dominant central server and subordinate client kiosks. An updated version of the client/server model utilizes the Internet with the web server dominating the model.

The associated business process mirrors the hierarchical and centralized technology. Participation in the client/server business process requires permission from the central authority. Intellectual property content storage is limited to central authority-designated servers. The current business processes have large capital requirements, resulting in oligopolistic organization of the distribution of music and movies. The resulting business organization has reduced revenue to the creators of intellectual property and reduced choice at the retail level.

What is needed is a method for the sale and distribution of intellectual property that reduces capital requirements, increases revenue to the creators of intellectual property, and increases choice at the retail level.

### SUMMARY OF THE INVENTION

The aforementioned needs are met to a great extent by the present invention which provides a method for the sale and distribution of intellectual property in which intellectual property stored on an intellectual property owner's computer is sold to buyers through a kiosk. The kiosk provides users with the ability to locate desired content on a seller's computer. In one embodiment, when a user locates the desired intellectual property, a payment transaction is initiated through an administration server, which brokers the transaction. In another embodiment, when a user locates the desired intellectual property, a payment transaction is initiated which is brokered through system software running on the kiosk or seller machine and which does not require a centralized administration server. When the payment transaction is complete, the seller transmits the intellectual property to the kiosk. The kiosks preferably include production facilities that transfer the owner's intellectual property onto a permanent medium such as paper, CD-ROM, DVD, VCR, etc., and/or presentation facilities that present the owner's intellectual property on a one-time basis. The kiosks may be located in retail stores, factory floors, in other public areas, or in private homes and may be attended or unattended. The method and system provides any seller of intellectual property with a distribution network without the high entry barriers associated with known methods of intellectual property distribution. The system and method also benefits retailers of intellectual property as the necessity of maintaining inventories of media imprinted with intellectual property is eliminated. The system also benefits industrial users of intellectual property as it will reduce the cost of production.

### BRIEF DESCRIPTION OF THE DRAWINGS

The aforementioned advantages and features of the present invention will be more readily understood with reference to the following detailed description and the accompanying drawings in which:

FIG. 1 is a block diagram of a brokerage network according to a first preferred embodiment of the present invention.

FIG. 2 is a flowchart illustrating the seller registration process according to a first preferred embodiment of the present invention.

FIG. 3 is a flowchart illustrating the purchasing process according to a first preferred embodiment of the present invention.

FIG. 4 is a block diagram of a brokerage network according to a second preferred embodiment of the present invention.

FIG. 5 is a flowchart illustrating the seller registration process according to a second preferred embodiment of the present invention.

FIG. 6 is a flowchart illustrating the purchasing process according to a second preferred embodiment of the present invention.

### DETAILED DESCRIPTION

In the following detailed description, a plurality of specific details, such as types of storage media and operating systems, are set forth in order to provide a through understanding of the present invention. The details discussed in connection with the preferred embodiments should not be understood to limit the present invention.

It should be understood that references in the following detailed description to intellectual property or content also refer to licenses (such as tickets) for exhibitions or presentations of intellectual property. These exhibitions or presentations may be live (e.g., a concert) or reproduced (e.g., a movie).

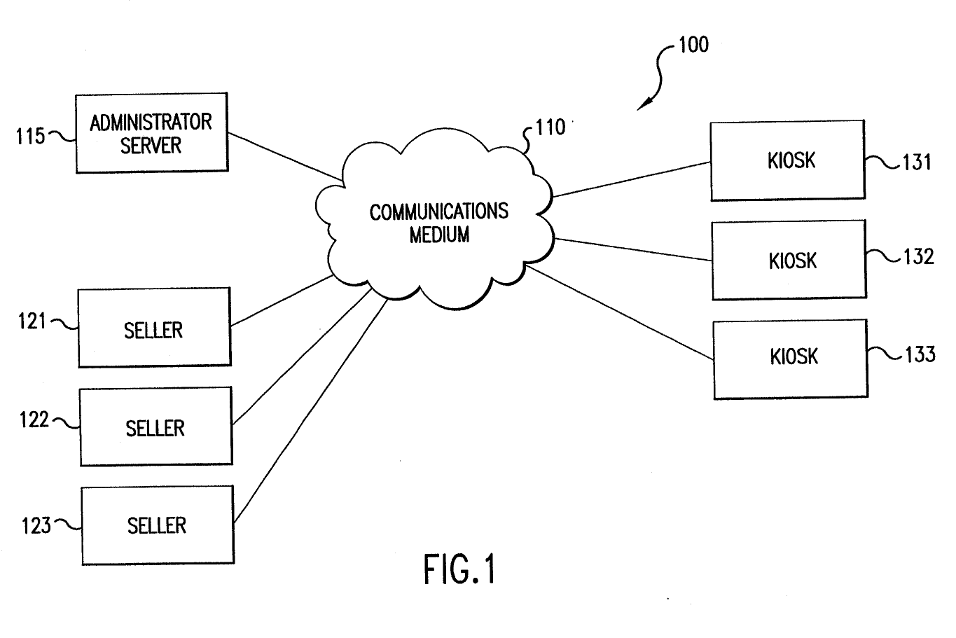

FIG. 1 is a block diagram of an intellectual property brokerage system according to a first preferred embodiment 100 including an administration server 115, a plurality of kiosks 131-133 and a plurality of seller computers 121-123 connected to each other via a communications network 110. In preferred embodiments, the system 100 is implemented using an “open standards” architecture. The communications network 110 is preferably implemented using TCP/IP over a public packet switched network such as the Internet. Private networks and other protocols may also be used.

The system architecture is composed of modular components. Each component may have more than one implementation (e.g., specific hardware or software or combinations thereof). This permits users of the system to choose an implementation that is appropriate to their circumstance. An implementation of a component design uses the best technology available at the time to fulfill the component design. Over time, improvements in technology will present better ways to implement a component design. Components may be reimplemented at any point in time using the latest technology.

The administration server 115 performs a number of different functions. First, the administration server 115 maintains databases for participants in the system 100. The information concerning the participants includes lists of authorized participants, their type of authorization (e.g. buyers, sellers, both), and contact information. The administration server 115 also maintains a database of the content being offered by sellers and/or content sought by buyers. It should be noted that the database does not contain the content itself; rather, the information merely identifies the location of the content and the seller offering the content for sale. This information in the databases may be maintained using any method, including Relational Database Management Systems (RDBMS); Object Database Management Systems (ODBMS), ASCII files, and others. Although the information is maintained on one or more administration servers 115 in preferred embodiments, the information may also be distributed (located on individual participant computers).

In addition to maintaining the participant and content databases, the administration server 115 also provides system software to new participants. In preferred embodiments, the system software may be downloaded by a participant over the communications medium 110. Once downloaded, the system software may be installed on a new seller computer 121-123 or kiosk 131-133. The administration server 115 may also employ load balancing algorithms to ensure that the administration server 115 does not become a bottleneck in the flow of content between buyers and sellers.

Furthermore, the administration server 115 also brokers transactions. Authentication, authorization, and other security functions are implemented with standard security technologies such as passwords, encryption, synchronous and asynchronous keys, digital certificates, and message digests.

In preferred embodiments, the administration server 115 is a network consisting of a burstable T1 internet connection, a zoned firewall, and redundant rackable server class web, mail and database servers running Java, Oracle IAS and Oracle 8i database.

The kiosks 131-133 preferably include two modules: the Merchant module and the Buyer module. These modules may be implemented on a single computer or may be implemented on separate computers. When implemented on a single computer, the modules may simply comprise separate applets running in a Web browser.

The Merchant module provides proxyed Internet gateway access between the Buyer module and the Administration server 115. The Merchant module also decrypts content received from a seller computer and the handles the presentation of that content and/or the transfer of the content to a storage medium such as a writable CD-ROM. The Merchant module is also involved with payment transactions in some embodiments as will be described in further detail below. Additionally, the Merchant module maintains a content database locally in some embodiments for efficiency purposes. The Merchant module is preferably implemented on a personal computer with an Intel Pentium 500 Mhz processor running Windows NT and a Java run time and preferably includes an Internet connection as well as a CD writer, a printer, a video capture card and a VCR. Preferably, a combination router/modem and packet filtering firewall such as the Netopia 7200 is configured to deny all connections except from the system administration 115, the Buyer module, and authorized sellers.

The Buyer module functions principally a display device. It provides the monitor and a pointing device that allows the user to interact with the system. The Buyer module is preferably implemented on a diskless Unix appliance equipped with an Intel processor, 256 Mb memory, a bootable CD (which contains the Unix OS, device drivers and a browser), a monitor, and an Ethernet connection to the Merchant Module. Through the Buyer module resident browser, buyers can access a web server running on the Merchant module to search the content database maintained at the administration server or, in some embodiments, the content database maintained locally by the Merchant module for desired intellectual property, as well as input payment information (e.g., credit card numbers).

It should be understood that, although the kiosks 131-133 have been described above as comprising both Buyer and Merchant modules, it is possible for several Buyer modules to share a Merchant module. For example, in one contemplated implementation, a retail establishment may provide several Buyer modules located in a customer area of the store. Each of these Buyer modules may be networked to a single Merchant module located in a protected area of the store such as behind a counter. In such an embodiment, retail customers search for desired content at the Buyer module. A payment transaction is then initiated. The different methods for initiating the payment transaction are discussed in greater detail below. Once payment is completed, the content is received at the Merchant module and transferred to a storage media. The customer then proceeds from the Buyer module to the counter, where store personnel hand the media to the customer.

In other embodiments, unattended kiosks, which may be located in public areas such as shopping malls, include both a Buyer and Merchant Module. In such embodiments, both modules may be contained in a single physical kiosk.

Alternatively, the kiosks 131-133 may be implemented on a home computer using a home configuration. The software for the home computer may be downloaded from the administration server 115 or may be obtained by other means.

The Seller computers 121-123 may be any computer that can store content for sale and that can communicate over the communications medium 110 with the administration server 115 and the kiosks 131-133.

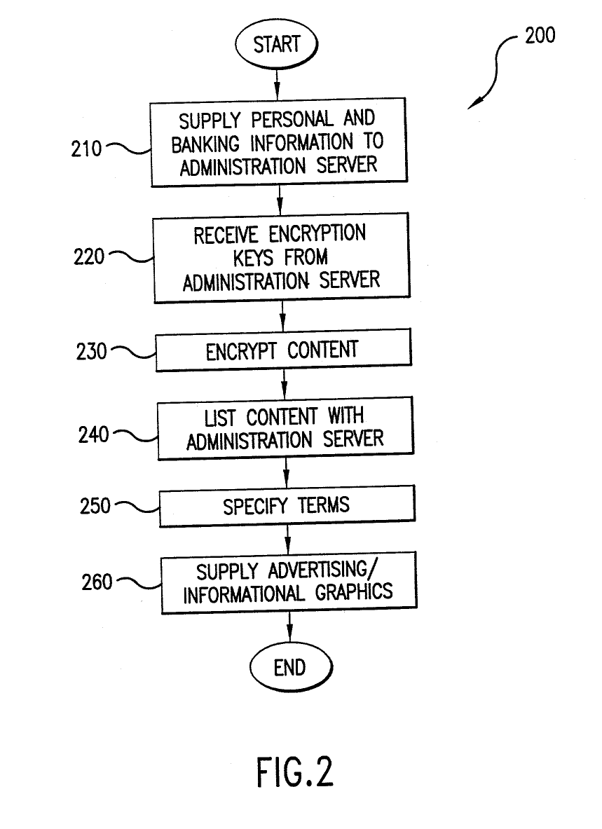

The first step for a seller wishing to sell content on the system 100 is for the seller to register with the administration server 115. Referring now to FIG. 2, the first step 210 in the seller registration process 200 consists of supplying sufficient personal and banking information to securely conduct business with the other participants in the system 100. Personal encryption and authentication keys, which are generated by the administration server 115 during registration in preferred embodiments, are received by the seller at step 220. Methods for processing payment transactions over the Internet using such keys are well known in the art and will not be discussed in further detail herein.

Next, the content to be sold on the system 100 is encoded and encrypted at the seller's computer using the keys obtained from the administration server 115 at step 230. At step 240, the content is listed with the administration server 115. (In embodiments in which content databases are stored locally at kiosks 131-133, the local databases are updated by the Administration server 115). The seller provides information such as the title or other description of the intellectual property. This information will be used to allow potential buyers to locate the content. In addition, the terms under which the content is offered are also specified at step 250. In preferred embodiments, the administration server 115 provides several exemplary license and/or sales agreements from which a seller may elect to offer the content. The seller preferably is also allowed to supply their own terms under which the content is to be offered rather than selecting from one of the exemplary licenses or sales agreements. The seller may also supply informational and/or advertising graphics at step 260. If the seller represents an event producer or a venue selling tickets, the seller will provide a graphical depiction of a map of the venue and assign seat numbers and ticket prices for presentation at a kiosk 131-133.. The seller may also supply advertising clips for display at kiosks 131-133 during periods when the kiosks 131-133 are not being used for a sales transaction.

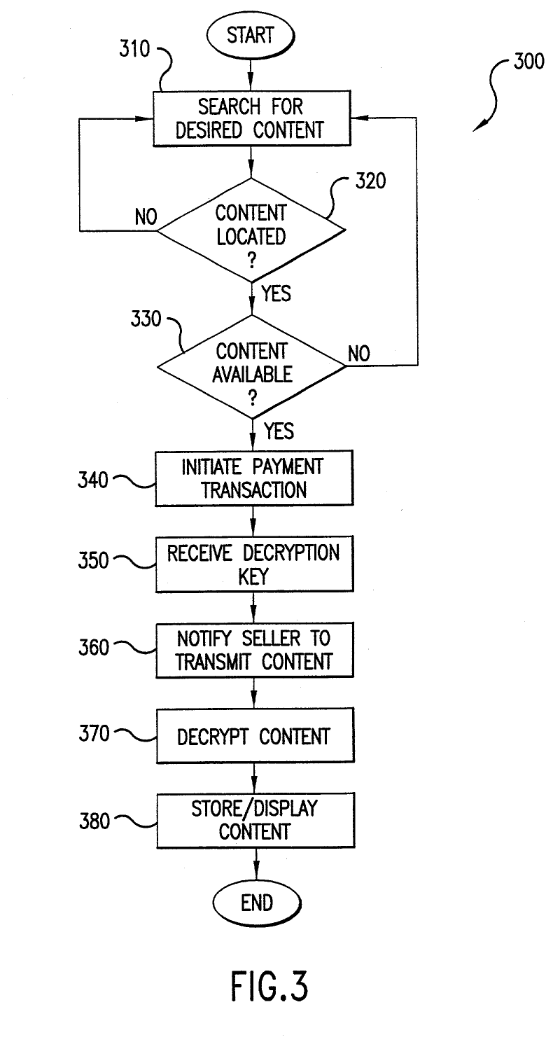

Once the seller has completed the registration process 200, content is available to potential purchasers. The purchasing process 300 will now be described with reference to FIG. 3. A purchaser begins the process by using the resident web browser of a Buyer module of a kiosk 131-133 to search for desired content at step 310. Agent technology may be employed in the search for desired content. If the content is not located at step 320, step 310 is repeated. Once the content has been located at step 320, the Administration server 115 determines whether the content is available at step 330. This step is necessary because the content is not stored centrally and it is possible that a seller's computer may not be accessible at any given time. If the content is not available, the purchaser continues searching at step 310. If content is available, a payment transaction is initiated at step 340.

Upon initiation of the payment transaction, the Buyer module displays the terms under which the content is being offered to the purchaser. The purchaser must accept these terms for the payment transaction to continue.

Payment transactions may be accomplished in a number of ways. In some embodiments, the customer simply enters a credit card number (either by swiping it through a card reader or using a keypad to enter the digits) at the Buyer module. The Buyer module then transmits the credit card number to the Merchant Module, which in turn transmits it to the Administration server 115. The administration server 115 brokers the debiting of an account associated with the credit card with a financial institution and the corresponding crediting of the seller's account. In one business model, there is a “spread” between these amounts that is retained by the Administrator server 115. Some of this spread represents profit to the operator of the Administrator server 115. Some of the spread may be shared with the owner of the kiosks 131-133 as compensation for providing and maintaining the kiosks 131-133. This method is particularly well suited to unattended kiosks, but may be used in a retail establishment as well.

In another method of effecting the payment transaction, which is particularly applicable to a retail store environment with several Buyer modules networked to a single Merchant module as described above, the user of the Buyer module simply selects the desired content. The Merchant module passes the request along to the Administration server 115, which then automatically debits the account of the owner of the Merchant module. In this business model, the owner of the Merchant module has previously agreed to be invoiced by the Administration server 115 on some periodic basis (e.g., monthly). The Administration server 115 then credits the account of seller. Unlike the credit card transaction described above, in this business model, no actual transfer of funds occurs. Rather, the Administration server maintains an internal accounting of transactions and funds are transferred when invoices are issued. The seller then sends the content to the Merchant module, which in turn readies it for display or stores it on a storage medium. The user of the Buyer module (the ultimate customer) then pays the operator of the retail establishment, at which point the medium is handed to the customer and/or the display of the content is commenced. This method has the advantage of being able to handle cash transactions rather than requiring the use of a credit card. This method could, of course, also be used with unattended kiosks provided that a means for accepting cash payments (such as coin slots and other payment devices associated with common vending machines) was provided.

Numerous other schemes for effecting payment transactions are also possible. These schemes, which are well known in the art and will not be discussed in further detail herein, should be understood to be encompassed by the present invention. As used herein, the term “broker” should be understood to encompass any means by which funds are ultimately transferred from a purchaser of intellectual property to the seller of the intellectual property.

Once the payment transaction has been completed at step 340, the Merchant module then receives the key needed to decrypt the seller's content from the Administration server at step 350. Next, the Administration server notifies the seller to transmit the encrypted content to the Merchant module at step 360. The received content is decrypted by the Merchant module at step 370. The Merchant module 370 then stores the content on a medium or displays it to the user via the Buyer module at step 380 to complete the sale. Any money due from the purchaser is collected at this time.

In some embodiments, a cache capability is provided, preferably under the control of the seller. Intellectual property that is frequently sold over the system 100 may be stored locally at a kiosk (if agreed to by the seller) in order to avoid requiring repeated downloads. One situation where caching might be particularly valuable is when a kiosk is in a location such as a record store and a new work is released by a popular recording artist. In this situation, multiple copies of the new work may be sold in a short period of time. By caching the work at the kiosk, the time delays associated with repeated downloads are avoided.

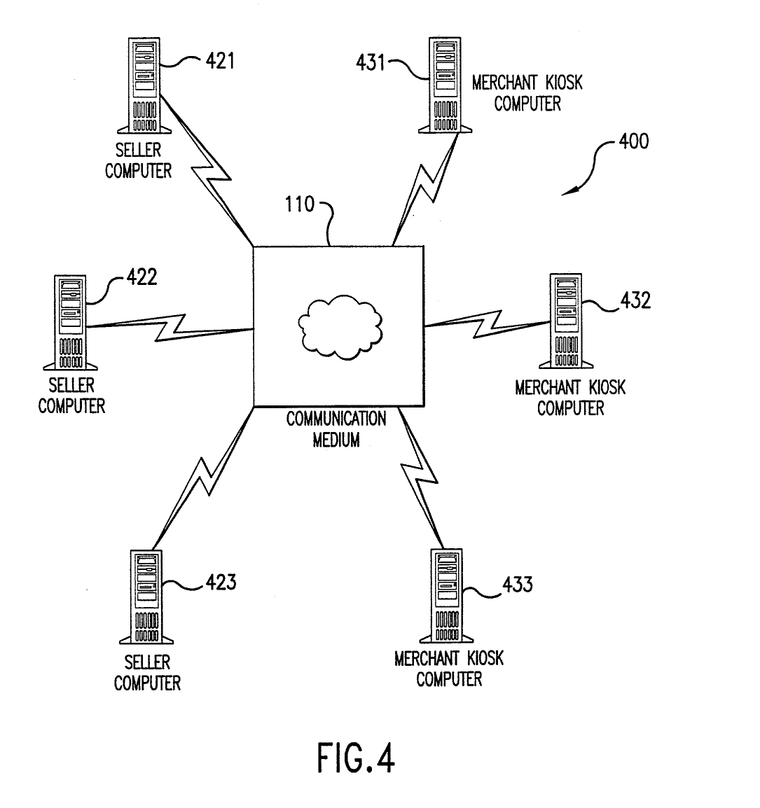

In the first preferred embodiment discussed above, the administration server 115 participates in the brokerage of transactions. In a second preferred embodiment, the administration server 115 does not participate in the brokerage of transactions. The system architecture of this embodiment is a server-less, peer-to-peer network 400 as shown in FIG. 4. In the system 400, a plurality of seller computers 421-423 are connected to a plurality of kiosks 431-433 through communication medium 110, similar to the first embodiment described above. In this embodiment, as in system 100 described above, content is transmitted directly from a seller 421-423 to a kiosk 431-433.

In the system 400, potential sellers and merchants visit a website (not shown in FIG. 4), which describes the computer requirements for participating in the system 400. Once the appropriate computer is obtained, software is downloaded from the website and installed on the computer. The software includes utilities, a public encryption key, and a list of registered kiosks.

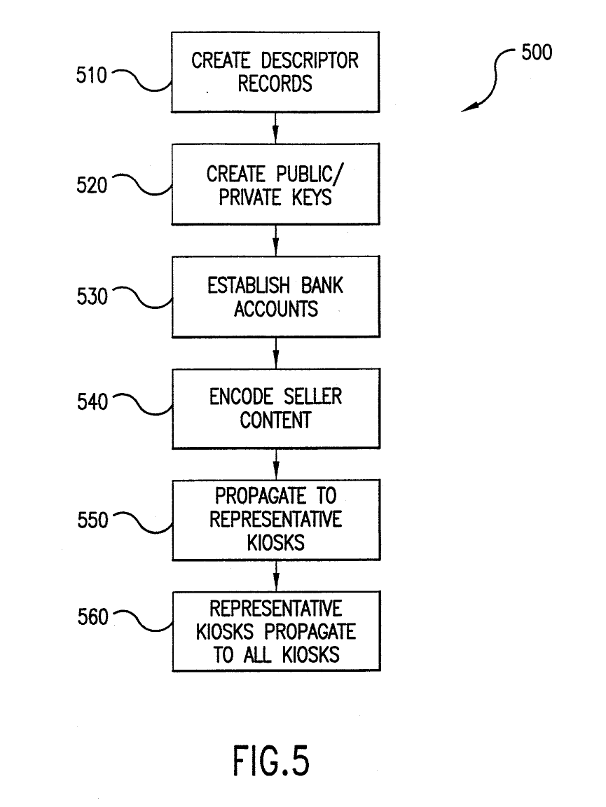

Once the computer has been appropriately configured with the software, a seller begins the registration process 500 illustrated in FIG. 5. Registration is the process of creating descriptor records containing identifying information about a seller, seller content, merchant or other data and adding it to the registration database. The registration database maintains sufficient information for users of the system to locate content and each other. The complete registration database is present on each kiosk computer 531-533. The registration database is kept current through a process of propagation described below. Each new seller machine 521-523 has a list of kiosks to contact to being propagating the seller content information to all other kiosks 531-533 in the system 400.

In preferred embodiments, the registration database is composed of a number of keyed, indexed, random-accessed ASCII files. The database is read only during hours of operation, improving performance of searches. New descriptor records propagated to a kiosk 531-533 are held in queue and then added to the registration database at that kiosk during a nightly batch database rebuild process. The database rebuild adds new records and rebuilds the keys and indexes. Multiple high performance disk drives, specialized search algorithms, and optional compression and deletion of unused descriptor records enable the registration database to grow to significant size.

At the start of the registration process 500, descriptor records are created for each intellectual property seller at step 510, which is performed with the aid of the downloaded software. The descriptor records include personal information, financial information, and information about the seller's computer.

Next, at step 220, a public/private key pair are generated. The public key is included in a descriptor record. The private key is securely stored on the computer. At step 230, the merchant (the operator of the kiosks 531-533) and the seller establish accounts with a financial institution service provider. In preferred embodiments, bank account and credit card transactions are outsourced to a financial institution. Accounts provided by the financial service provider are accessible to computers in the system 400.

Each unit of content being offered for sale is encoded at the seller's computer 421-423 at step 540. Each unit of content must be stored on the seller's computer in a standard encoded format. To encode a unit of content, the seller uses one of the utilities included with the downloaded software. The seller enters descriptive and labeling information about the content. The seller may include sample clips for advertising purposes. If the seller is an event producer or venue selling tickets, a map of the venue may be included. The content is encrypted using the private key obtained at step 520. The content is then compressed and stored on the seller's computer. The encoding process also creates a descriptor record for each unit of content, which is then ready for propagation to the kiosks 531-533.

The descriptor records are propagated to representative kiosks at step 550. Additional representatives from a group are contacted if the first representative does not acknowledge receipt. To aid in propagation, kiosks are divided into geographic groups consisting of thousands of kiosks per group. Each kiosk maintains the complete list of all the kiosks in its group as well as a list of several representative kiosks from every other group. A representative is any kiosk which has agreed to assist with the administration of the system 400. Representative kiosks assist with propagation traffic and make available the system software for download to other computers. Payment processing programs recognize representative kiosks and pay the representative kiosks an administration fee. Any kiosk can be a representative kiosk. There is no limit to the number of groups or the number of representative kiosks in a group. Representative kiosks are normally those kiosks with a history of high volume and consistent up time. Representative kiosks run regular performance monitoring programs to measure performance and availability of all other representative kiosks. Once the seller has propagated the descriptor records to the representative kiosks, the representative kiosks propagate the descriptor records to all other kiosks at step 560.

In preferred embodiments, the system administrator may divide existing groups or start new groups. Kiosks become representatives kiosks by applying to the system administrator and receiving a representative kiosk designation. Upon designation of a kiosk as a representative, the system administrator propagates a descriptor record informing the system 400 of the new representative kiosk. Representative kiosks can become decertified if the uptime and other quality factors fall below a predetermined level.

An alternative design employs traffic analysis software to determine if an existing group needs to be divided. Periodically, the group's top performing kiosk will run the traffic analysis routine. If the group has grown beyond a threshold point, results from the performance-monitoring program will be used to select the new representative kiosks. The selected representatives are e-mailed an acceptance form to consent to selection. Descriptor records will be generated announcing new groups and representatives.

Propagation can alternatively be implemented using mbone or ip multicast. An optional architectural alternative to maintaining local kiosk databases through propagation is to use one or more central servers to process and store descriptor records. In this alternative, descriptor records would be implemented as relational database tables or other objects inherent in the chosen database management system.

It should be understood that the seller machine, instead of or in combination with the kiosks, could store and propagate the descriptor database.

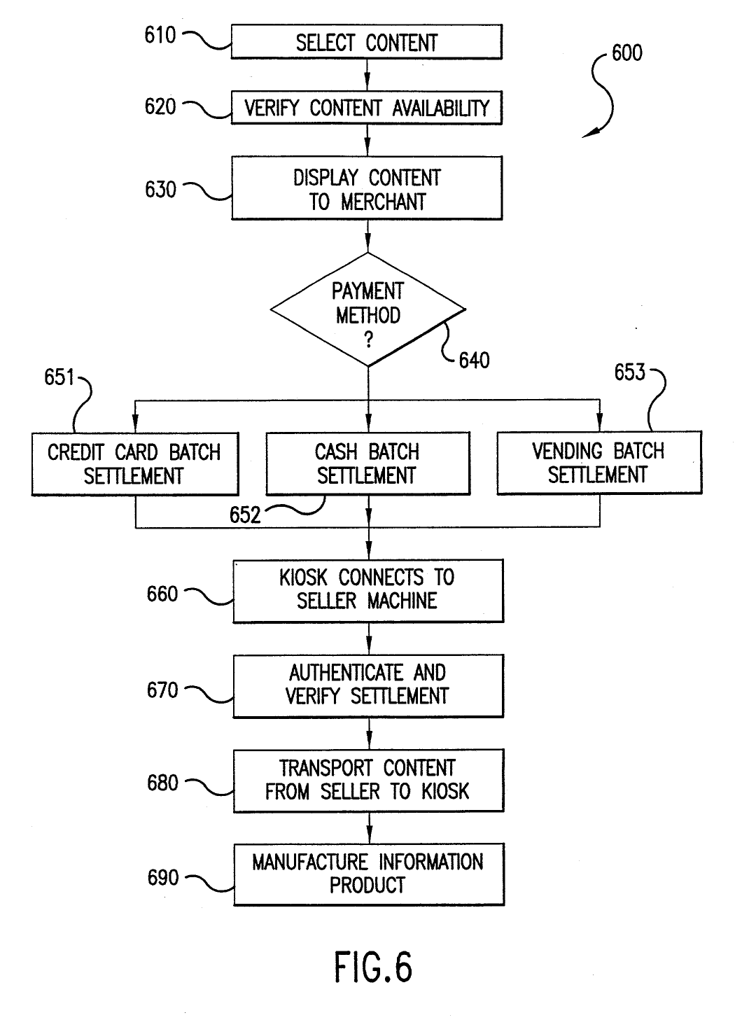

After registration is complete, content is available for purchase. The purchasing process 600 will be described with reference to FIG. 6. A buyer begins the purchasing process 600 by using the kiosk buyer module. The buyer searches for and selects desired content at step 610. A buyer may register and configure an agent to search for content while the buyer waits or to contact the buyer in the future when content becomes available that meets the buyer's criteria. Once content is selected, the kiosk verifies that the content is available at step 620. If the content is unavailable, a descriptor record noting the unavailability will be propagated to kiosks in the system 400.

If the content is available, a more detailed description of the content and the terms of sale are presented to the buyer at step 630. If the buyer accepts the terms, the payment transaction begins with the buyer being queried, at step 640, as to which mode of payment is desired. If the buyer indicates a credit card transaction, then the kiosk connects to the financial service provider, which executes a credit card batch settlement program at step 651. Batch settlement of electronic buyer payment consists of debiting the buyer account, then crediting the seller, merchant and the system administrator account the appropriate amounts (e.g., seller gets purchase price less a commission of X%, which is shared between the merchant and the system administrator).

If the buyer pays the merchant cash, the financial service provider cash batch settlement program 652 is executed. The purchase amount, less the merchant fee, is deducted from the merchant bank account. The seller and system administrator accounts are then credited with the appropriate amounts.

If the buyer pays cash through coin slots or other means at a kiosk (such as an unattended kiosk), the kiosk executes the financial service provider vending batch settlement program at step 653. The price less a fee is debited from the merchant's account and the system administrator and seller's account are credited the appropriate amounts.

Each of the financial service provider batch settlement programs return a record which contains an unencrypted error code indicating the success or failure of the settlement program. The return record also contains information encrypted with the private key of the financial service provider. The encrypted information in the return record includes the public key of the purchasing kiosk, the seller's content file number, and the amount paid.

In the above description, the kiosk initiates the transaction in that the kiosk sends a message to the financial service provider. It will readily be appreciated that the message to the financial service provider could be sent from the seller machine rather than from the kiosks. In such embodiments, a message from the kiosk to the seller machine authorizing the transaction may be necessary, such as in an embodiment in which the kiosk is configured to accept cash from the buyer.

If the settlement was successful, transmission of content begins. The kiosk connects to the seller at step 660 and present s the encrypted financial service provider return record. The seller machine retrieves the public key from the financial service provider and decrypts the return record. The decrypted return record is used to authenticate the connection and verify the settlement at step 670. The seller then permits the merchant module to copy the content along with the necessary decryption keys at step 680. After the content has been transported, it is made available to the purchaser, either by copying it onto a storage medium or presenting it on a display device on a one time basis, at step 690. As above, numerous alternative payment options exist.

Although the above descriptions discuss the distribution of intellectual property in a buyer-initiated context, it should be understood that the invention is equally applicable to a seller-initiated context. That is, the invention may accept from a buyer an identification of intellectual property desired to be purchased along with desired terms. Prospective sellers may search the list of desired intellectual property and terms and elect to sell the desired intellectual property to the buyer, with the transaction being brokered by the Administration server 115. As above, agent technology may be used to match buyers with sellers in this context.

Obviously, numerous modifications and variations of the present invention are possible in light of the above teachings. It is therefore to be understood that within the scope of the appended claims, the invention may be practiced otherwise than as specifically described herein.

What is claimed is:

1. A method for distributing intellectual property comprising the steps of:
accepting identification information of intellectual property being offered for sale from a seller, the intellectual property being stored on a seller computer associated with the seller;
storing the identification information in a database of intellectual property being offered for sale;
providing access to the database to a user;
accepting a designation of desired intellectual property from the user;
brokering a payment transaction between the user and the seller; and
instructing the seller computer to transfer the intellectual property to the user.

2. The method of claim 1, further comprising the steps of:
providing a plurality of agreements under which intellectual property may be distributed to the seller;
accepting a selection of one of the plurality of agreements from the seller;
providing an agreement selected by the seller to the user; and
requiring the user to accept the agreement selected by the user prior to performing the instructing step.

3. The method of claim 1, wherein the database is stored on a single server.

4. The method of claim 1, further comprising the step of verifying that intellectual property chosen by the user is available before performing the brokering step.

5. A system for distributing intellectual property, the system comprising:
a central server, the central server including a database of intellectual property being offered for sale, the intellectual property being stored on a plurality of seller computers;
a plurality of kiosks connected to the central server, each of the kiosks being configured to perform the steps of
displaying a list of the intellectual property being offered for sale to a user;
accepting a selection of intellectual property from the user;
transmitting payment information to the central server;
receiving intellectual property corresponding to the selection from a seller computer; and
making the received intellectual property available to the user.

6. The system of claim 5, wherein the making step is performed by displaying the received intellectual property on a monitor.

7. The system of claim 5, wherein the making step is performed by storing the received intellectual property on a storage medium.

8. The system of claim 7, wherein the storage medium is a compact disk.

9. The system of claim 7, wherein the storage medium is a DVD.

10. The system of claim 7, wherein the storage medium is a floppy disk.

11. The system of claim 7, wherein the storage medium is paper.

12. The system of claim 7, wherein the storage medium is videotape.

13. The system of claim 5, wherein the payment information is a credit card number.

14. The system of claim 13, wherein the kiosks further comprise card readers for reading the credit card number.

15. The system of claim 5, wherein the central server is configured to transmit a copy of the database to the kiosks and the kiosks are configured to maintain a local copy of the database.

16. The system of claim 5, wherein the central server further includes a database of terms under which the intellectual property is being offered.

17. The system of claim 16, wherein the terms correspond to terms selected by a seller from a plurality of standard terms presented to the seller by the central server.

18. The system of claim 16, wherein the terms correspond to terms supplied by a seller.

19. The system of claim 5, wherein the kiosk is further configured to perform the step of caching frequently purchased intellectual property.

20. The system of claim 5, wherein the kiosk is implemented on a single computer.

21. A method for distributing intellectual property comprising the steps of:
storing intellectual property being offered for sale on a computer associated with a seller;
storing a identification of the intellectual property in a database;
providing access to the database to a purchaser;
accepting a selection of intellectual property from a purchaser;
brokering a payment transaction between the user and the seller; and
transporting the intellectual property from the seller to the purchaser.

22. The method of claim 21, wherein the database is stored on a computer used by the purchaser.

23. The method of claim 21, wherein the database is stored on the seller's computer.

24. The method of claim 21, further comprising the step of determining whether the intellectual property is available from the computer associated with the seller.

25. A device for distributing intellectual property comprising:
a memory, the memory including a list of intellectual property being offered for sale, the intellectual property being stored on a plurality of seller computers, the list further including an address for each seller computer;
a display device; and
a processor connected to the memory and the display device, the processor being configured to perform the steps of:
displaying the list to a purchaser;
accepting a selection of intellectual property from a purchaser;
transmitting payment information from the purchaser to a third party for brokerage;
receiving the intellectual property from the seller; and
making the intellectual property available to the purchaser.
